(19) United States
(12) Patent Application Publication
(10) Pub. No.: US 2010/0206109 A1
(43) Pub. Date: Aug. 19, 2010

(54) Drive Device

(76) Inventors: Robert Wolfgang Kissel, Egelsbach (DE); Frank Neumann, Niedernberg (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/675,463

(22) PCT Filed: Aug. 26, 2008
(86) PCT No.: PCT/EP08/61164

§ 371 Date: Mar. 31, 2010

(30) Foreign Application Priority Data
Aug. 21, 2007 (DE) 10 2007 041 342.6

(51) Int. Cl. F16H 3/16

(52) U.S. Cl. 74/333

(57) ABSTRACT

A driving device for the rotary or pivoting drive of a constructional unit about an axis of rotation with an electric motor which has a driving pinion which is arranged on a drive shaft and by means of which, via a gearing arrangement, a driven shaft running perpendicularly to the drive shaft can be rotatably driven, the rotational movement of which driven shaft can be transmitted to the axis of rotation of the constructional unit. The gearing arrangement has a crown wheel gearing which can be driven rotatably by the driving pinion of the drive shaft, and a cycloid gearing which is connected downstream of the crown wheel gearing and by means of which the driven shaft can be driven rotatably.

### PRIORITY CLAIM

This is a U.S. national stage of application No. PCT/EP2008/061164, filed on 26 Aug. 2008, which claims priority to the German Application No.: 10 2007 041 342.6, filed: 31 Aug. 2007, the content of both incorporated herein by reference.

### BACKGROUND OF THE INVENTION

1. Field of the Invention

The invention relates to a driving device for driving a unit to rotate or pivot about a rotary shaft, having an electric motor with a drive pinion arranged on a drive shaft by which an output shaft, which runs perpendicular to the drive shaft, can be rotatably driven via a gear mechanism arrangement, it being possible for the rotary movement of the output shaft to be transmitted to the rotary shaft of the unit.

2. Prior Art

Units which can be pivotably driven by electric motor are known, for example, as on-board monitors on the dashboard of motor vehicles.

The on-board monitor, together with its driving device, is arranged in an opening in the dashboard and can be pivotably driven, by the driving device, between an approximately horizontal inactive position which closes the opening and an approximately vertical active position.

Since space on the dashboard is limited, the required installation space should be minimized.

### SUMMARY OF THE INVENTION

An object of the invention is to provide a driving device of the type mentioned in the introduction which requires only a small amount of installation space.

According to one embodiment of the invention, this object is achieved by a gear mechanism arrangement having a contrate gear mechanism, which can be rotatably driven by the drive pinion of the drive shaft, and a cycloid gear mechanism that is connected downstream of the contrate gear mechanism by which the output shaft can be rotatably driven.

This design results in a low installation space requirement along with a high possible transmission ratio and an equally high degree of efficiency.

Axial play of the drive shaft of the electric motor does not result in any negative influence when the drive pinion of the drive shaft of the electric motor engages in the contrate gear wheel of the contrate gear stage.

The contrate gear stage permits a space-saving axial offset between the drive pinion and the contrate gear wheel of preferably 90°. In principle, the axial offset can be selected to be between 0° and 135°, depending on the installation space conditions.

The contrate gear stage has a further advantage that it produces very little noise during operation.

Although the contrate gear stage exhibits a high degree of efficiency, it does not allow a particularly high transmission ratio. However, this is compensated for by the cycloid gear mechanism that has a high transmission ratio. Therefore the combination of a contrate gear mechanism and a cycloid gear mechanism is particularly advantageous.

A non-positive clutch is preferably arranged between the output shaft and the rotary shaft of the unit.

This clutch, which can overcome force, prevents damage to the unit and injury to people who, for example, may trap a body part, such as a hand or a finger, between the unit and a stationary component during an adjustment operation. Therefor; the clutch forms a trapping- and overload-prevention device.

The driving device is also prevented from being destroyed in the event of improper use, for example if the unit is pulled or pushed by hand.

One option for providing a non-positive clutch is for the rotary shaft of the unit to be a polygonal shaft which has wrench flats and that projects into a cylindrical hole in a bushing which can be rotatably driven by the output shaft, with the edge spacing of the polygonal shaft corresponding to the diameter of the cylindrical hole in the bushing. The bushing has one or more recesses that intersect the cylindrical hole in the bushing and have springs that project into the recesses, which are prestressed radially inward, and rest both on a wrench flat of the polygonal shaft and also against the wall of the recess with prestress.

In this case, the recess can be a tangential groove that extends at a right angle to the longitudinal extent of the polygonal shaft, the groove base extending in a plane parallel to a wrench flat of the polygonal shaft.

The spring is self-retaining, if the spring is a clamp spring that projects into the recess by way of a spring arm.

A double spring action is achieved by a single spring component by virtue of two diametrically opposite recesses being formed in the bushing. The recesses have walls that extend parallel to one another, and in each case, one spring arm resting against one of the walls and against one of the wrench flats with prestress.

In another embodiment, the non-positive clutch can be a frictional clutch, with the rotary shaft of the unit or a component which is connected to said rotary shaft in a rotationally fixed manner having a frictional surface which rests, with spring prestress, against a mating frictional surface of the output shaft or a component which can be rotatably driven by the output shaft.

In a further space-saving embodiment, the non-positive clutch can be a magnetic-force clutch.

The magnetic-force clutch can be a dog clutch. The claw bodies of the dog clutch, which claw bodies are arranged such that they are movably guided along the rotary shaft of the unit, being subjected to the action of a permanent-magnet force in corresponding recesses in the output shaft or a body which can be rotatably driven by the output shaft.

A gear wheel or toothed segment, which can be rotated about the rotary shaft of the unit and can be connected to the unit in a rotationally fixed manner, can be rotatably driven by the output pinion which is arranged on the output shaft of the gear mechanism arrangement.

If, in this case, the non-positive clutch is rotationally connected between the gear wheel or the toothed segment and the rotary shaft of the unit, excessive-load separation is performed in the vicinity of the unit on which the excessive load is acting.

The unit is preferably an indicator device, in particular an electro-optical display of a motor vehicle, with the display being arranged on the dashboard of the motor vehicle and it being possible for said display to be pivotably driven between a folded-in inactive position and a swung-open active position.

### BRIEF DESCRIPTION OF DRAWINGS

Exemplary embodiments of the invention are described below and illustrated in the drawings, in which

FIG. 1 is a perspective view of an electro-optical display having a driving device

FIG. 2 is a first perspective view of the driving device according to FIG. 1;

FIG. 3 is a second perspective view of the driving device according to FIG. 1;

FIG. 4 is a third perspective view of the driving device according to FIG. 1;

FIG. 5 is a first perspective view of a clutch of the driving device according to FIG. 1;

FIG. 6 is a second perspective view of a clutch of the driving device according to FIG. 1;

FIG. 7 is a third perspective view of a clutch of the driving device according to FIG. 1;

FIG. 8 is a fourth perspective view of a clutch of the driving device according to FIG. 1;

FIG. 9 is a fifth perspective view of a clutch of the driving device according to FIG. 1;

FIG. 10 is a perspective view of a second exemplary embodiment of a clutch;

FIG. 11 is a cross section through the clutch according to FIG. 10; and

FIG. 12 is a perspective view of a third exemplary embodiment of a clutch.

### DETAILED DESCRIPTION OF THE DRAWINGS

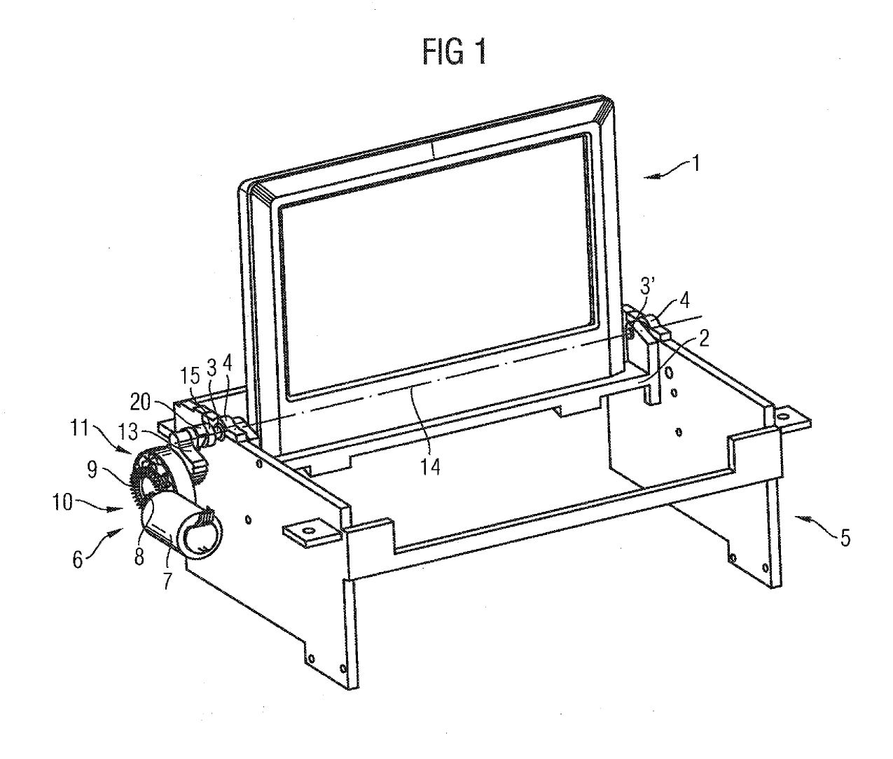

The display 1 illustrated in FIG. 1 is arranged, at its lower edge, on a support 2 which has horizontally projecting bearing pins 3 and 3′ on both sides of the display 1.

The display 1 is pivotably mounted on bearings 4 of a frame-like installation mount 5 by the bearing pins 3 and 3′.

The installation mount 5 can be inserted into a corresponding opening in a dashboard 50 of a motor vehicle.

The bearing pin 3 and, with it, the support 2 and the display 1 can be pivotably driven by a driving device 6. The driving device 6 has an electric motor 7, which can be driven in reverse. A drive pinion 8, which engages in the teeth of a contrate gear wheel 9 of a contrate gear mechanism 10, is arranged on a drive shaft of the electric motor 7. The drive shaft preferably extends at a right angle to the longitudinal extent of the bearing pins 3 and 3′ in a space-saving manner.

The contrate gear wheel 9 is rotatably mounted about a shaft arranged at a right angle to the drive shaft of the electric motor 7.

A cycloid gear mechanism 11 connected downstream of the contrate gear mechanism 10 is rotatably driven by the output drive of the contrate gear mechanism 10, and an output pinion 12 (FIG. 3) is arranged on the output shaft of the cycloid gear mechanism. The output pinion 12 engages in the teeth of a toothed segment 13 which is rotatably mounted about the rotary shaft 14 of the display 1. The rotary shaft 14 is preferably formed by the bearing pins 3 and 3′.

A cylindrical bushing 15 is firmly arranged on the toothed segment 13 coaxially to the rotary shaft 14. One end of the bearing pin 3 which is in the form of a polygonal shaft 16 projects into the cylindrical hole 19 in said cylindrical bushing. (FIG. 5)

In this case, an edge spacing of the polygonal shaft 16 corresponds to the diameter of the hole 19 in the bushing 15.

Tangential grooves 17 are formed on the bushing 15, said tangential grooves being diametrically opposite one another at a right angle to the longitudinal extent of said bushing 15 and being so deep that the groove bases of said grooves extend in the same plane as one of the wrench flats 18. (FIG. 6)

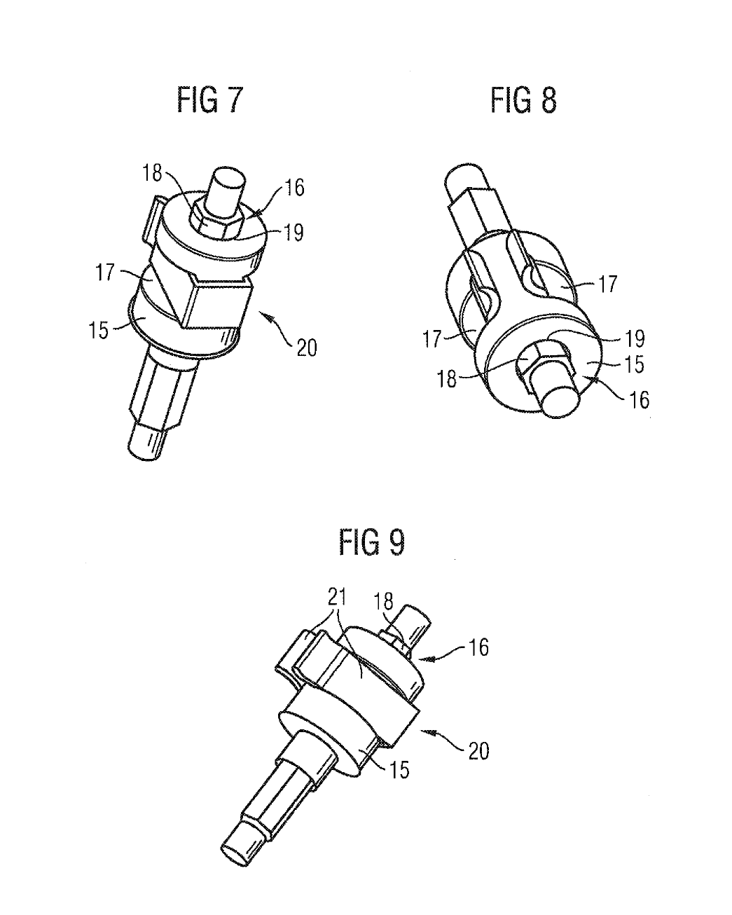

A clamp spring 20 with two spring arms 21 which are approximately parallel to one another is mounted on the bushing 15 in such a way that in each case one spring arm 21 extends into one of the grooves 17 and rests, with prestress, both against the groove base of this groove 17 and also against a wrench flat 18 of the polygonal shaft 16. (FIGS. 5-9)

As a result, the bushing 15 and the polygonal shaft 16 are coupled to one another to transmit a rotary movement. The rotary movement exerted on the drive pinion 8 by the electric motor 7 is transmitted to the bearing pin 3 and, with it, to the display 1 by the gear mechanism unit, which is formed by the contrate gear mechanism 10 and the cycloid gear mechanism 11, and the toothed segment 13.

If the display 1 is prevented from pivoting on account of being stuck, the torque which has to be overcome is increased such that the spring arms 21 of the clamp spring 20 open outward, and this leads to the rotary connection being opened.

It is possible to prevent the rotary movement by inserting an object or a body part, such as a human finger, into the pivoting region of the display 1 and said object or body part becoming trapped between the display and the installation mount 5 or the dashboard. Significant damage to the object or the body part can be prevented by uncoupling the bearing pin 3 from the bushing 15.

However, even in the illustrated active position of the display, force can be applied to the non-driven display 1 in the pivoting direction leading to the non-positive clutch, i.e. clamp spring 20, being released and thus damage to the driving device being avoided.

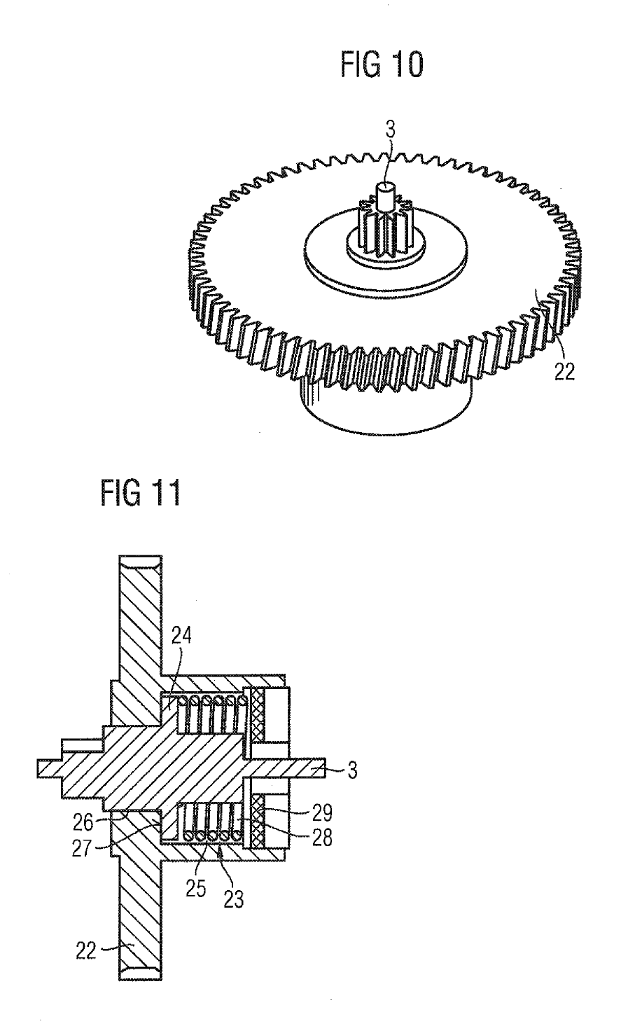

In the exemplary embodiment of FIGS. 10 and 11, a gear wheel 22 is provided instead of a toothed segment 13, said gear wheel having a stepped hole 23.

The bearing pin 3, which is provided with a radial extension 24, projects into the stepped hole 23, the surface of said radial extension 24 which faces the radial transition 26 from the large step 25 to the small step 26 of the stepped hole 23 forms a frictional surface 27.

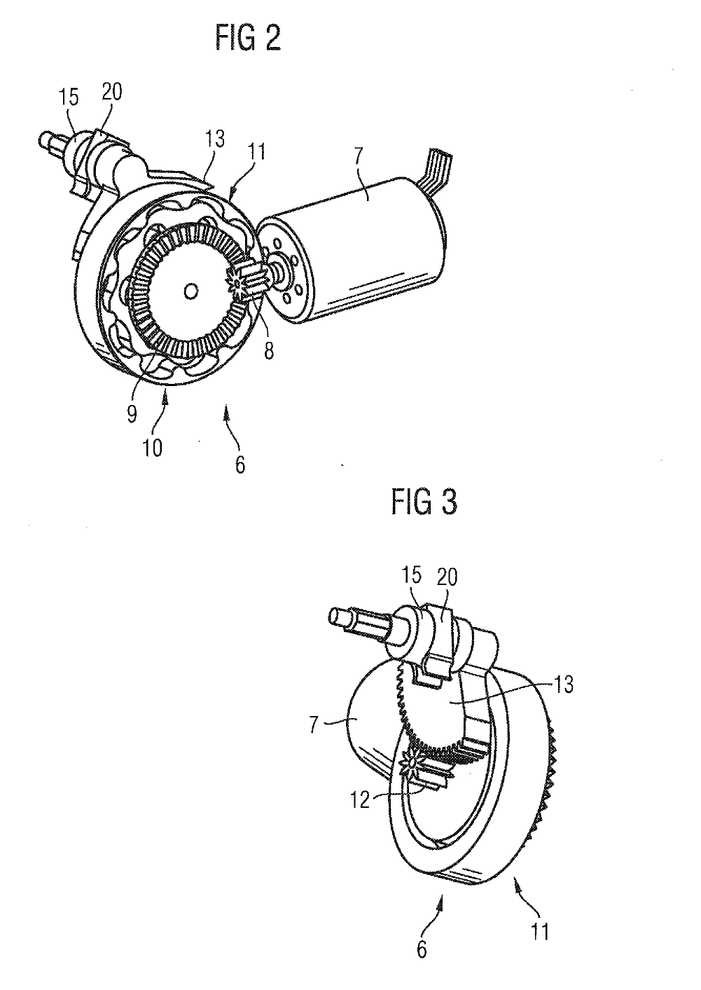

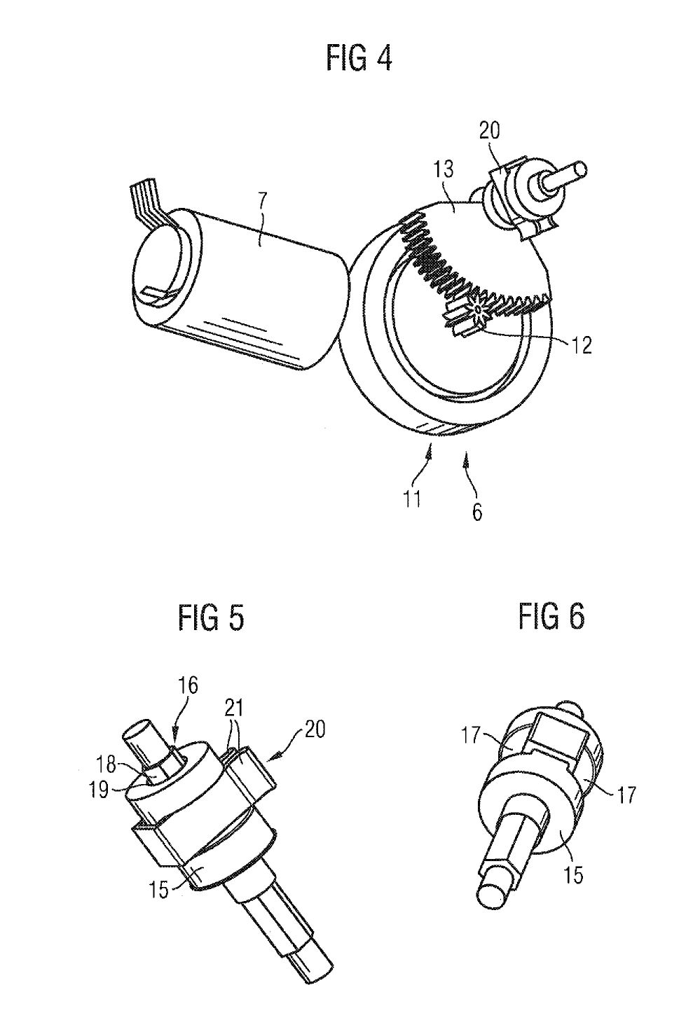

The frictional surface 27 acts on a mating frictional surface, which is formed by the radial transition 26, by virtue of a helical compression spring 28 which acts, with prestress, on that surface of the radial extension 24 which is opposite the frictional surface 27, and therefore a non-positive frictional clutch is formed, it being possible to release said frictional clutch under the same conditions as in the exemplary embodiment of FIGS. 2 to 4.

The helical compression spring 28 is preferably supported, by way of its end which is opposite the radial extension 24, on a supporting ring 29 which is firmly arranged on the inner wall of the large step 25 of the stepped hole 23.

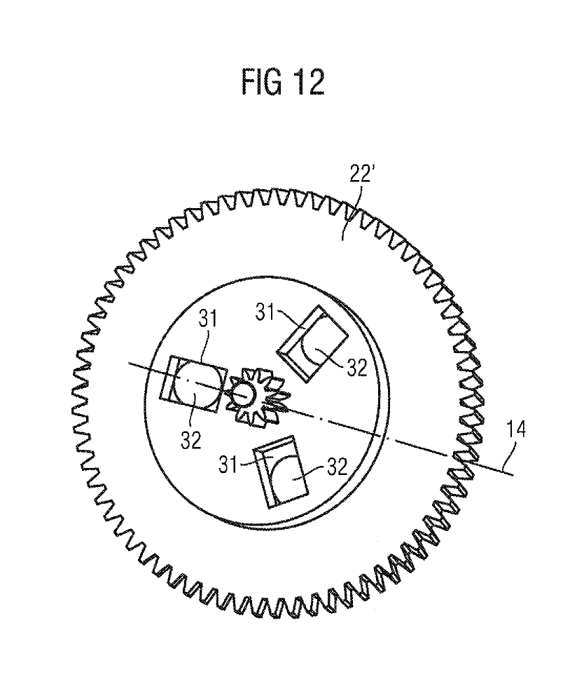

A gear wheel 22′ is likewise provided instead of a toothed segment 13 in the exemplary embodiment according to FIG. 12.

The disk-like component 30, which is connected to the bearing pin 3 in a rotationally fixed manner, is situated coaxially to the gear wheel 22′. (FIG. 12)

Continuous chambers 31, in which spherical claw bodies 32 are arranged such that they can move in an axial manner, are formed uniformly and distributed about the circumference in the disk-like component 30.

Recesses (not illustrated), into which the metal claw bodies 32 are drawn by permanent magnets (40), which are arranged in the gear wheel 22′, by way of part of their circumference, are formed in the gear wheel 22′ in the same pitch circle as the chambers 31, and therefore a dog clutch which is produced by magnetic force is formed between the gear wheel 22′ and the disk-like component 30 which is firmly connected to the bearing pin 3, it being possible to release said dog clutch under the same conditions as in the exemplary embodiment of FIGS. 2-4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A driving device configured to drive a unit to pivot about a rotary shaft, comprising:
an electric motor comprising a drive shaft;
a drive pinion arranged on the drive shaft;
an output shaft arranged perpendicular to the drive shaft configured to be rotateably driven, the output shaft coupled to the rotary shaft; and
a gear mechanism arranged between drive pinion and the output shaft configured to be driven by the drive pinion to translate rotary movement of the output shaft to be transmitted to the rotary shaft of the unit, the gear mechanism comprising:
a contrate gear mechanism configured to be rotatably driven by the drive pinion; and
a cycloid gear mechanism connected downstream of the contrate gear mechanism, the cycloid gear mechanism configured to rotatably drive the output shaft.

16. The driving device as claimed in claim 15, wherein a non-positive clutch is arranged between the output shaft and the rotary shaft.

17. The driving device as claimed in claim 16, further comprising:
a bushing having a cylindrical hole and one or more recesses that intersect the cylindrical hole in the bushing; and
a spring,
wherein the rotary shaft is a polygonal shaft having wrench flats, the polygonal shaft projecting into the cylindrical hole in the bushing, an edge spacing of the polygonal shaft substantially corresponding to a diameter of the cylindrical hole in the bushing, the spring configured to project into the recesses prestressed radially inward to rest both on a respective wrench flat of the polygonal shaft and prestressed against a wall of the recess.

18. The driving device as claimed in claim 17, wherein the recess is a tangential groove extending substantially perpendicular to the longitudinal extent of the polygonal shaft, a groove base of said groove extending in a plane parallel to the respective wrench flat of the polygonal shaft.

19. The driving device as claimed in claim 17, wherein the spring is a clamp spring comprising a spring arm projecting into the recess.

20. The driving device as claimed in claim 19, wherein two diametrically opposite recesses are formed in the bushing, said two recesses having parallel extending walls, wherein one spring arm rests against a respective one of the walls and against one of the wrench flats with prestress.

21. The driving device as claimed in claim 16, wherein the non-positive clutch is a frictional clutch.

22. The driving device as claimed in claim 21, wherein one of the rotary shaft and a component connected to the rotary shaft in a rotationally fixed manner comprises a frictional surface configured to rest with spring prestress against one of a mating frictional surface of the output shaft and a component which can be rotatably driven by the output shaft.

23. The driving device as claimed in claim 16, wherein the non-positive clutch is a magnetic-force clutch.

24. The driving device as claimed in claim 23, wherein the magnetic-force clutch is a dog clutch, claw bodies of the dog clutch are arranged such that they are movably guided along the rotary shaft, the claw bodied configured to be subjected to the action of a permanent-magnet force in corresponding recesses in one of the output shaft and a body configured to be rotatably driven by the output shaft.

25. The driving device as claimed in claim 16, wherein one of a gear wheel and a toothed segment is configured to be rotated about the rotary shaft and connected to the unit in a rotationally fixed manner and driven by an output pinion arranged on the output shaft of the gear mechanism.

26. The driving device as claimed in claim 25, wherein the non-positive clutch is rotationally connected between one of the gear wheel or the toothed segment and the rotary shaft.

27. The driving device as claimed in claim 16, wherein the unit is an indicator device of a motor vehicle.

28. The driving device as claimed in claim 27, wherein the indicator device is arranged on a dashboard of the motor vehicle and can be pivotably driven between a folded-in inactive position and a swung-open active position.

29. The driving device as claimed in claim 27, wherein the indicator device is an electro-optical display of the motor vehicle.

30. The driving device as claimed in claim 29, wherein the indicator device is arranged on a dashboard of the motor vehicle and can be pivotably driven between a folded-in inactive position and a swung-open active position.

31. The driving device as claimed in claim 15, wherein the output shaft is integrally formed with the rotary shaft.
